(19) United States
(12) Patent Application Publication
(10) Pub. No.: US 2025/0360862 A1
(43) Pub. Date: Nov. 27, 2025

(54) MOUNTING STRUCTURE FOR AN ACCESSIBILITY DEVICE

(71) Applicant: Valeda Company, LLC, Oakland Park, FL (US)

(72) Inventors: Randy Rivera, Oakland Park, FL (US); Gareth Holloway, Birchington (GB); James Douglas Wiles, Whitstable (GB)

(21) Appl. No.: 19/214,846

(22) Filed: May 21, 2025

Related U.S. Application Data
(60) Provisional application No. 63/650,814, filed on May 22, 2024.

(51) Int. Cl. B60P 7/08; A61G 3/08; B62D 25/20; F16B 11/00

(52) U.S. Cl. CPC B60P 7/0815; F16B 11/006; A61G 3/0808; B62D 25/2054

(57) ABSTRACT

A method for mounting an accessibility device into an OEM vehicle without drilling holes is provided. The method may comprise an adapter mounting structure roughly configured to the profile of the accessibility device, that may have at least one or more fasteners to secure to the accessibility device. The adapter mounting structure may be bonded to the OEM vehicle floor using adhesives. The adapter mounting structure may be installed in OEM vehicles alongside a floor system. The floor may have cutout roughly configured to the profile of the adapter mounting structure to allow the adapter mounting structure to adhere directly to the OEM vehicle floor. The adapter mounting structure may have features that engage with the floor system to further strengthen the support.

### CROSS REFERENCE TO OTHER APPLICATIONS

This application claims priority to U.S. Provisional Patent Application No. 63/650,814, filed on May 22, 2024, entitled “MOUNTING STRUCTURE FOR AN ACCESSIBILITY DEVICE,” the contents of which are incorporated herein by reference. This application incorporates by reference the contents of PCT Patent Application No. PCT/US25/30291, filed on May 21, 2025, U.S. Patent Application Publ. No. 2023/0257026, published on Aug. 17, 2023, and U.S. Pat. No. US 2023/0048271 A1, published on Feb. 16, 2023.

### FIELD OF THE DISCLOSURE

The present disclosure relates generally to a passenger vehicle that has been modified to allow access by a physically limited passenger, and more particularly to methods of installing various accessibility devices—including but not limited to wheelchair lifts, wheelchair ramps, wheelchair securements, occupant restraints, swivel seats, and seat supports.

### BACKGROUND

This section introduces aspects that may help facilitate a better understanding of the disclosure. Accordingly, these statements are to be read in this light and are not to be understood as admissions about what is or is not prior art.

Automobile manufacturers do not currently mass-produce passenger motor vehicles specifically designed to transport passengers having physical limitations, either as a driver or as a non-driving passenger. Consequently, mass-produced passenger vehicles are modified, or retrofitted, by a number of aftermarket companies dedicated to supplying vehicles to physically limited passengers. Such vehicles can be modified by installing parts specifically designed to accommodate the physically limited passenger. Accessibility devices that may be fitted to an accessible vehicle includes, but is not limited to, a ramp or lift, swivel chairs, and wheelchair tiedown and occupant restraint system (WTORS).

There are various methods of installing these systems in a vehicle, many of which require mounting hardware that secures the device to the OEM vehicle floor. This hardware requires holes to be drilled in the vehicle floor. Drilling holes through the floor could be a dangerous process as there are many electrical wires and fluid lines running underneath the vehicle that could be damaged. Electric and hybrid vehicles often position the battery underneath the vehicle floor as well, so the OEM often outlines a “No Drill Zone” to avoid damage to the battery. Too many holes could also compromise the overall structural integrity of the floor. Not following the OEM drilling instructions could result in voiding the manufacturer's warranty for the vehicle. Therefore, accessible vehicle outfitters needed a method to install accessibility devices without modifying the OEM floor.

For the reasons listed above, accessible vehicle outfitters have started installing longitudinally- or laterally-extending tracks in or on the floor that are configured to receive, engage with, and support various structures, such as WTORS and seats. In another known configuration, a vehicle can be retrofitted to include a floor system that is installed on top of the OEM floor. The floor system may be constructed of extruded aluminum and may include integrated tracks that may have a similar profile as the widely used L-track for mounting WTORS and seats. In any of these configurations, the van will also typically be retrofitted with a wheelchair lift or a ramp, to enable a physically limited individual using a wheelchair to enter and exit the vehicle. Due to the high loads to which they are subjected and the fact that they do not need to be moved from one location to another in regular practice, wheelchair lifts and some WTORS are still solidly bolted through the vehicle floor (including the floor system, if present) to the vehicle sub-structure. As previously mentioned, drilling holes has many shortcomings, so another method of mounting must be considered.

Drilling mounting holes also increases the difficulty and resources needed to install accessibility devices. If an accessibility device bolts through the OEM vehicle floor, installers will need access to the underside of the vehicle to fasten the bolts. Reaching the underside of a vehicle either requires lifting the vehicle in the air, or a cumbersome process of maneuvering in tight spaces underneath the vehicle.

Due to the limitations outlined previously, there is an unmet need for a method of mounting high loaded accessibility devices in a vehicle that does not require drilling mounting holes in the vehicle floor.

### SUMMARY OF THE EMBODIMENTS

In one embodiment, an accessible vehicle is provided that incorporates an adapter mounting structure that is bonded to the OEM floor. The accessibility device may be a WTORS, wheelchair ramp or lift, swivel seat, seating, or any other accessibility device that typically requires drilling holes through the OEM floor to mount in the vehicle. The adapter plate may be secured to the OEM floor by adhesive. The adapter mounting structure may have hardware fixedly mounted to the adhered surface for the accessibility device to fasten to.

In another embodiment, the mounting of an accessibility device using an adapter mounting plate combined with a floor system on top of the OEM floor is considered. The floor system may have a cutout of the profile of the accessibility device such that when both the floor system and the adapter mounting structure are adhered to the OEM floor, the accessibility device fastens to the adapter plate and is set inside the cutout of the floor system. This mounting provision assists with the height of the device within the vehicle and reduces the height of a low-profile device such as a WTORS, such that a wheelchair may maneuver over and onto the device.

In another embodiment, a singular structure or a plurality of adapter mounting plates is considered. For an accessibility device with a large mounting area, the adapter structure may be split into multiple separate structures, each of which may have fastening point of the device. This method could be considered to assist with weight reduction of the vehicle to improve the efficiency and the capacity to carry passengers in the vehicle. The material and thickness of the adapter mounting structure is also considered to minimize the additional weight of the system, while maintaining the structural integrity of the mounting of the accessibility device. For mounting using a plurality of adapter structures, a method of locating the plurality of adapter structures using a template is contemplated. The template may be a bracket only used for installation or could be a stripped-down frame of the accessibility device. The template may also be considered to locate the profile by which the floor system needs to be cut to allow room for mounting the accessibility device to the adapter structure.

In another embodiment, non-planar adhering surfaces are contemplated for the adapter mounting structure. OEM floors may be corrugated, so a flat plate would reduce the surface area of adherence by only contacting the “peaks” of the corrugation. The adhering surface may have protrusions that offset from the main surface to meet up with the “valley” of the corrugated OEM floor. The extra surfaces may not be part of the main adhering structure. Separate shims may be used to accommodate OEM floors that have dimensionally different corrugated profiles.

In another embodiment, increasing the load capacity of the adapter mounting structure by means of contacting the floor system is considered. Since the floor system is typically bonded to the whole OEM floor, there is a greater surface area of bonding that can provide greater strength. Because of this, the adapter mounting structure may underlap the bottom surface of the floor system when adhered to the OEM floor. The floor system may also have cavities in the body, so the adapter mounting structure may contact the floor system interior of the cavities as well. The adapter mounting structure may also include offset features that contact the top surface of the floor system such that it can be bolted to the tracks using sliders that insert to the track. Additionally or alternatively, sliders that may be installed into tracks may have a tapped hole horizontally along the length of the slider configured to receive a bolt that may be horizontally inserted through an hole in a vertical feature of the mounting structure.

In yet another embodiment, the cavities of the floor system have been considered for additional uses beyond structural. Some WTORS and other accessibility devices have electric functionality that requires wires to be run from the vehicle to supply power to the device. The cavities in the floor system may be used to route these wires out of the way of the passenger area.

In another embodiment, the experienced loads by accessibility devices are considered to ensure the mounting structure is sufficiently supportive. Each accessibility device has a maximum load for which it is rated. It is essential that the mounting structure can support at least that maximum load so the accessibility device can perform to its rating. To ensure this, the strength of the adhesive and the area of the bonding need to be used to calculate the loads the structure can support. Adhesives typically have a tensile, peel, or shear strength rating given as a force per area, such as PSI or Pa. Using the free body diagram to draw out the loads experienced by the accessibility device, one can deduce the proper adhesive strength rating needed for the calculation. The second item needed in this calculation is the area of the bonding. If bonding to a flat surface, the area may simply be the surface area of the bonding surface of the mounting structure. However, OEM vehicle floors may not be flat surfaces. Often the OEM vehicle floors are corrugated, so while bonding to the floor, a flat mounting structure may only contact the high points of the corrugation, minimizing the area of bonding. To meet the required bonding surface area for the required loads, the surface area of the bonding surface of the mounting structure may be increased to contact more area of the high points of the corrugation. As previously discussed, increasing the size of the mounting structure increases the weight added to the vehicle which has limitations in vehicle performance. Alternatively, the mounting structure may be non-planar to contact the low points of the corrugation and increase the area of bonding. Additionally or alternatively, an intermediate shim may be used to bond the low points of the corrugation to the flat bonding surface of the mounting structure as it bonds to the high points of the corrugation to increase the bonding area of the mounting structure.

In another example of this embodiment, the installation process of the mounting structure in an OEM vehicle is contemplated. In this portrayal, the adhesive described is Bostik 70-03A, but may be any similar adhesive. The steps of installation may include: cleaning the bonding surface of the mounting structure and the OEM vehicle floor to remove contaminants that may compromise the adhesion; creating a cavity in a floor system if installed adjacent to the mounting structure, by either cutting out the profile of the mounting structure in the floor system or installing adjacent floor panels with a gap to fit the mounting structure; and, if the mounting structure is a plurality of brackets, fastening the plurality of brackets to a template bracket or the accessibility device for locating the brackets in the proper locations. The previous preparation steps may be completed in any order as they are not dependent on each other. If the OEM vehicle floor is corrugated, shims may be adhered in the valleys of the corrugation.

After preparation, the adhesive may be applied to the OEM vehicle floor or the bonding surface of the mounting structure. The adhesive should be applied at least 1/16 of an inch thick and in strips for sufficient airflow to assist curing. Adhesive should be carefully applied such that it is not squeezing out of the structure and curing in contact with the accessibility device itself when secured to the mounting structure. Features such as patterned holes may be added to the mounting structure to assist with airflow for curing and controlling the amount of adhesive that may ooze out when installing. An accelerant may also be used to speed up the curing process. The adhesive of this example has ten-minute skin forming time, so installers may continue working around the vehicle then. After applying the adhesive, the mounting structure, or structures attached to the template bracket, may be placed in the vehicle. While the adhesive is curing, the template may be left attached to prevent any shifting during curing. Alternatively, the template may be removed swiftly before the adhesive is cured, so that the final accessibility device may be fastened to the mounting structure while the adhesive is still wet in case the fasteners were slightly misaligned in the template.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 illustrates an example of a prior art vehicle interior that may be modified with accessibility devices installed in it.

FIG. 2 illustrates the vehicle of FIG. 1 with a floor system installed.

FIG. 3 illustrates a first embodiment of an adapter mounting structure that may be installed in a vehicle of the type shown FIGS. 1-2.

FIG. 4 illustrates a second embodiment of an adapter mounting structure integrated in a cutout of a floor panel for use with a floor system of the type shown FIG. 2.

FIG. 5 illustrates an exploded view of a WTORS that is adapted to be mounted in a cavity within a floor system of the type shown in FIG. 2 using a plurality of adapter mounting structures of the general type shown in FIG. 3 and a plurality of shims.

FIG. 6 Illustrates the WTORS of FIG. 5 installed in the vehicle in conjunction with a floor system of the type shown in FIG. 2.

FIG. 7 is a retractor used in a WTORS mounted within a floor system of the type shown in FIG. 2 with brackets that tie into and between adjacent panels of the floor system.

FIG. 8 illustrates a third embodiment of an adapter mounting structure integrated in a cutout of a floor panel for use with a floor system of the type shown FIG. 2.

Corresponding reference numerals are used to indicate corresponding parts throughout the several views.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

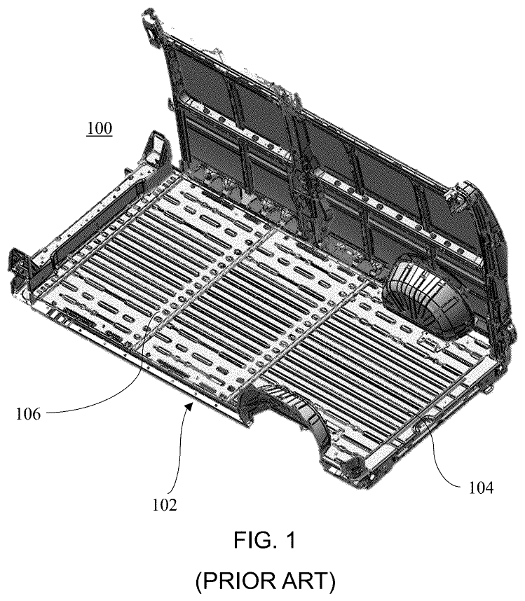

FIG. 1 illustrates the interior of typical layouts for OEM vehicles 100 (e.g., vans) that may be modified to permit access for a physically limited passenger. The modification of which may include installing accessibility devices on the OEM floor 102. The OEM floor 102 may have a corrugated surface with peaks 104 offset vertically higher than the valleys 106.

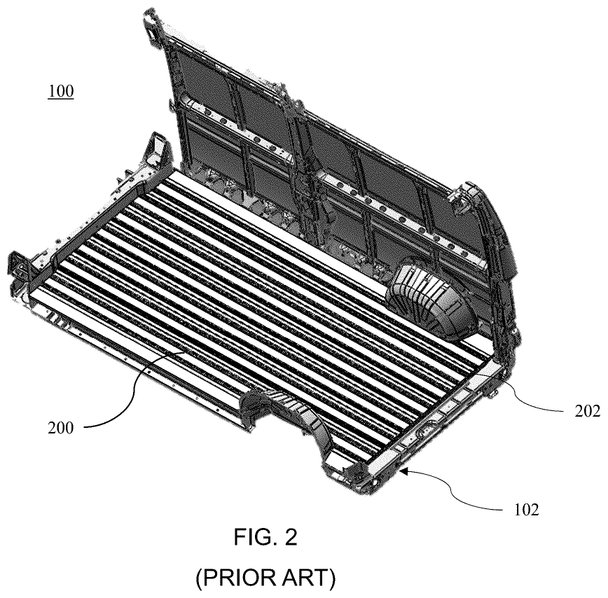

FIG. 2 illustrates the interior of the vehicle 100 with a floor system 200 installed on top of the OEM vehicle floor 102. The floor system 200 may be extruded from aluminum. The floor system may comprise multiple panels. The panels may be permanently connected together, for example by glue, welds, or detachably connected together, for example by mechanical locking structures at the panel edges whereby two panels may be connected by snapping together, which may include moving the edges of two adjacent panels together while they are positioned in the same plane, or tilting one panel relative to the other and rotating the tilted panel until the two panels are planar. The floor system 200 may be installed into vehicle 100 and secured by bolting, adhesives, or any combination thereof. The floor system 200 may have tracks 202 configured to secure accessibility devices. The tracks 202 may be uniform open-top channels defined by two inwardly directed lips and may additionally include a plurality of holes along the length of the open-top channel, whereby the two inwardly directed lips have a scalloped L-track type geometry.

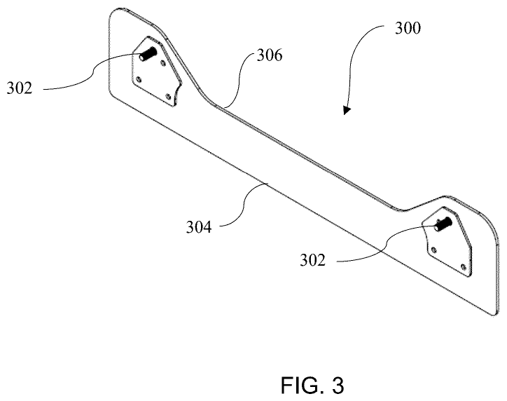

FIG. 3 illustrates one embodiment of an adapter mounting structure 300 that may have at least one or more fasteners 302 to secure to an accessibility device. The accessibility device may be a wheelchair ramp, lift, hoist, WTORS, seat, swivel seat, seat base, any other known device to permit access to a vehicle for a physically limited passenger, or any other structure intended to be mounted to the floor of a vehicle. The fasteners 302 may be threaded studs that extend upwards through the accessibility device structure and configured to receive a corresponding threaded nut to secure the accessibility device. The fasteners 302 may alternatively be a threaded nut by which a corresponding threaded bolt may be inserted through the accessibility device structure and attached to the nut to secure the accessibility device. The fasteners 302 may be press-fit into a feature in the adapter mounting structure 300, or secured to the adapter mounting structure 300 by welding or similar processes. The adapter mounting structure 300 may have a mounting surface 304 that an accessibility device may rest on when secured using the one or more fasteners 302. Opposite of the mounting surface 304, the adapter mounting structure 300 may have a bonding surface 306 that is used to affix the adapter mounting structure 300 to the OEM floor 102 using adhesive (not shown).

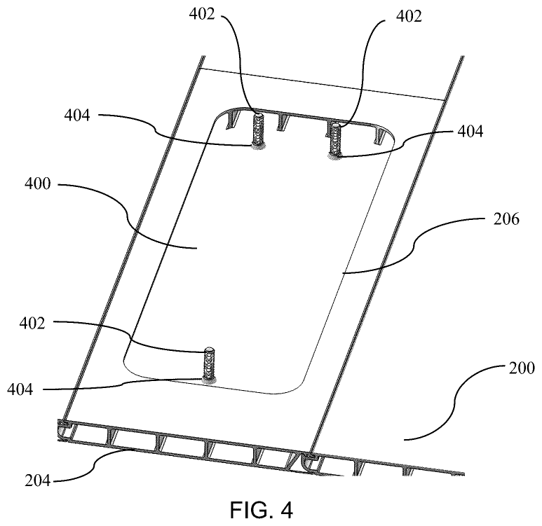

FIG. 4 illustrates another embodiment of an adapter mounting structure integrated in an aperture 206 of one or more panels of the floor system 200 that may be formed by cutting through the top surface of the panel, leaving the bottom surface 400 exposed through the aperture 206. The bottom surface 400 of the panel may further include one or more features 404 configured to fixedly receive fasteners 402. The fasteners 402 may be disposed inside of the perimeter of the aperture 206. The fasteners 402 may be a threaded stud, a threaded bolt, or any other commonly used method of fastening. The fasteners 402 may be press-fit into the features 404, welded into the features 404, or any other known method for affixing a fastener to a structure. In alternative embodiments, the fasteners 402 may be directly connected to the bottom surface 400. The fasteners 402 may be configured to receive and secure a structure to the floor system 200. In some embodiments, the structure may be mounted to the panel such that the structure is embedded within the aperture 206 and approximately flush with the top surface of the panel.

The panels of the floor system 200 may each have one or, as shown, a plurality of extruded channels 204. By virtue of the extrusion process, the extruded channels 204 may extend longitudinally from one end of the floor panel to the other and may take any shape. The extruded channels 204 may be open on one or both ends of the floor panel, or may be closed.

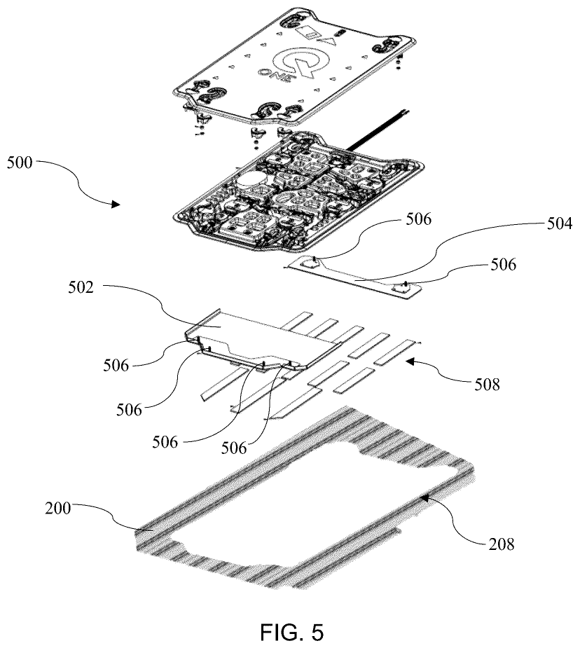

FIG. 5 illustrates an exploded view of a WTORS 500 and a plurality of adapter mounting structures that may have a first or rear adapter mounting structure 502 and a second or front adapter mounting structure 504. The rear adapter mounting structure 502 and the front adapter mounting structure 504 may have at least one or more fasteners 506 fixedly mounted to it to fasten to the WTORS 500. Although any WTORS may be secured by the adapter mounting structures described herein, the WTORS 500 as shown in the figures and disclosed in the prior art includes a housing having four wheelchair tiedown retractors, one passenger lap belt retractor, and one lap belt anchor. Each of those retractors and anchor must be independently secured to the OEM floor 102, thus six fasteners are provided in the adapter mounting structure. Other systems or structures being mounted to the floor may require more or less fasteners. The adapter mounting structure may be a single structure provided it includes all of the necessary fastening points for the system. The adapter mounting structure may also be a plurality of structures greater than two. In the disclosed example, two adapter mounting structures have been selected to optimize adhesive contact area for strength while not adding significant weight to the vehicle 100. When installing a plurality of adapter mounting structures, a template may be used to place the structures in the appropriate location, and to provide the appropriate spacing. The template may be a bracket used for installation or may be a frame of the accessibility device (or other structure) being installed. The template may temporarily fasten to the fasteners 506 such that an installer can place all of the plurality of adapter mounting structures in the proper locations at one time and leave while adhering. Once the adhesive is set, the template can be removed to give space for installing the accessibility device.

The rear adapter mounting structure 502 and the front adapter mounting structure 504 may be installed in a vehicle 100 and affixed to the peaks 104 of the OEM floor 102 using adhesive (not shown). Additionally, the plurality of shims 508 may be used as an intermediate to adhere the rear adapter mounting structure 502 and the front adapter mounting structure 504 to the valleys 106 of the OEM floor 102. The shims 508 are configured to have a width sufficient to fit in the valleys 106 of the OEM floor 102 and a height roughly equal to that of the peaks 104 of the OEM floor 102. When the bottom surface of the shims 508 is adhered to the valleys 106 of the OEM floor 102, the top surface of the shims 508 may be approximately flush with the peaks 104 of the OEM floor 102. This provides an approximately level surface for the adapter mounting structure 502 to adhere to. Addition of the shims 508 increases the surface area of adherence for the adapter mounting structures 502, 504. The strength of adhesives is typically specified by a unit of force per area. Therefore, increasing the adhering area increases the forces the adapter mounting structure 502, 504 can withstand. Increasing the area of the adapter mounting structure 502, 504 such that it spans over more peaks 104 of the OEM floor 102 to increase the adherence area is considered, but this has limitations as the increased adapter mounting structure 502, 504 would add additional weight to the vehicle 100. As shown, additional shims 508 may be provided underneath the WTORS 500 to provide additional support for the underside of the WTORS 500 housing. To provide additional support and securement for the WTORS 500, the portion of the underside of the WTORS 500 housing located central to the front and rear adapter mounting structure 502, 504 may be adhered to the peaks 104 and, via shims 508, to the valleys 106.

The WTORS 500 may be installed in a vehicle 100 in conjunction with a floor system 200. To reduce the height of the WTORS 500 extending above the floor system 200, a cavity 208 that may be formed by cutting through the extruded floor panels. The cavity 208 roughly correlates to the profile of the accessibility device, in this case a WTORS 500, may be added to the floor system 200. With the cutout, any one or more of the floor system 200, the adapter mounting structures, and accessibility device may be adhered to the OEM floor 102.

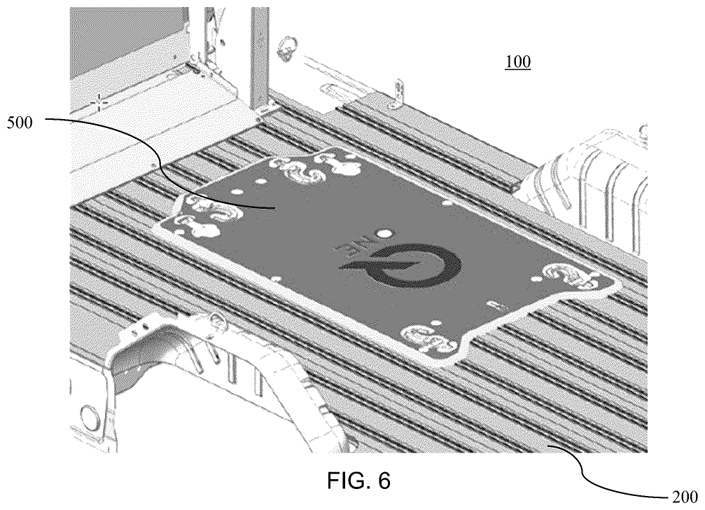

FIG. 6 illustrates the WTORS 500 installed inside of the vehicle 100 in in conjunction with a floor system 200.

In addition to the adapter mounting structures being adhered to the OEM floor 102, they may instead or additionally be connected, by any conventional means, to any other structures in the vehicle 100 such as the wall of the vehicle 100, pillars, or an aftermarket floor system. If additionally, this increases the support strength provided by the adapter mounting structures because not only will it be bonded to the OEM floor 102 with adhesives, but now it will also be structurally connected to separately mounted constructions connected to the vehicle frame. These constructions may be easier to access and connect to compared to drilling through the OEM floor 102, as discussed by the prior art limitations.

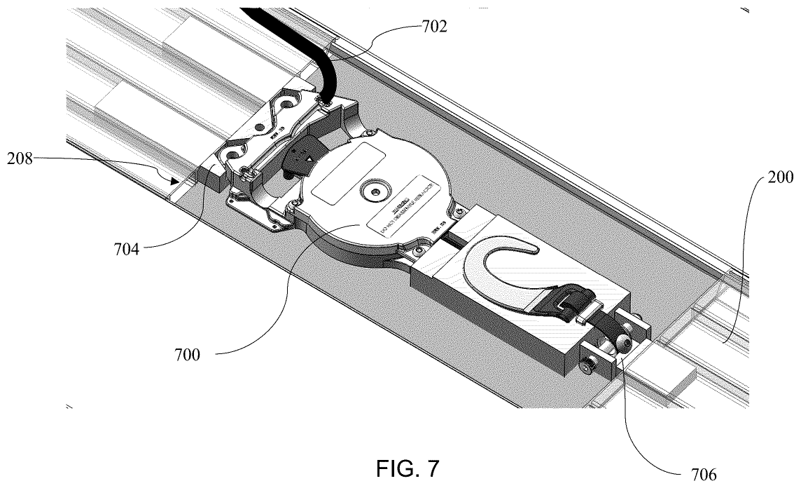

FIG. 7 illustrates one method of tying in a retractor 700 with a floor system to increase the support strength. The retractor 700 may be one of a plurality of retractors in a WTORS. The retractor may be installed in a cavity 208 of the floor system 200. The cavity 208 may be formed by cutting through the floor system 200, or the cavity 208 may be defined by a gap between two adjacent panels of the floor system 200, as shown.

The retractor 700 may include or be fastened to a plurality of flanges or bracket supports, a first or front flange or bracket support 704 and a second or rear flange or bracket support 706, that engage with the extruded channels 204 of the floor system 200 to provide more support for the loads transferred through the retractor 700. The front bracket support 700 may engage with one panel of the floor system 200 and the rear bracket support 706 may engage with a different panel of the floor system 200, the two panels defining the cavity 208.

While this embodiment shows a plurality of bracket supports extending forward and rearward, only one may be necessary. The bracket supports may alternatively or additionally extend left and/or right, depending on the construction and the orientation of the floor system 200. The bracket supports may have a cross section geometry configured to match the cross section of the extruded channels 204 of the floor system 200. The bracket supports may be a friction-fit or a snap-fit in the extruded channels 204. The bracket supports may also include one or more threaded nut or threaded hole that may receive a corresponding threaded bolt that extends through a corresponding aperture in the top surface (or, in other embodiments, a side or bottom surface) of the floor panel to lock the bracket support in the floor system 200.

This method of securing a retractor 700 may be used in addition to adhesives to provide further support or could be an alternative method where neither drilling holes in the floor nor adhesives for the adapter mounting structure are necessary. The mounting provisions are determined by the accessibility device and the forces that accessibility device may experience.

The retractor 700 may have electric, pneumatic, or hydraulic supply lines 702 that route through the extruded channels 204 of the floor system 200. Alternatively, the lines 702 may route underneath the floor system 200 in the valleys 106 of the OEM vehicle floor 102.

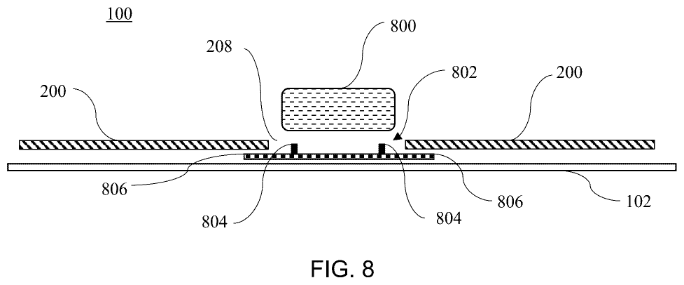

FIG. 8 illustrates another method of adding strength to an adapter mounting structure 802 by tying it in with a floor system 200, shown in a side section view of the vehicle interior 100. The floor system 200 may be connected to the OEM vehicle floor 102. The floor system 200 may have a cavity 208 for the device 800 to mount to the adapter mounting structure 802. The adapter mounting structure 802 may have a plurality of fasteners 804. The adapter mounting structure 802 may have one or more extensions 806 that underlap the floor system 200 to provide more support for the adapter mounting structure 802. In alternative embodiments, the extensions 806 of the adapter mounting structure may be substituted by flanges or bracket supports that are received in the floor system 200 extrusions 204 like the embodiment of FIG. 7.

This method of securement of an adapter mounting structure 802 may be used in addition to adhesives to provide further support or could be an alternative method where neither drilling holes in the floor nor adhesives are necessary. It depends on what accessibility device 800 is mounted to the adapter mounting structure 802 and what maximum forces the accessibility device 800 experiences.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A method for mounting an accessibility device to an accessible vehicle using a mounting structure having a bonding surface and a mounting surface, the mounting surface having at least one fastener, the method comprising the steps of:
adhering a bonding surface of the mounting structure to an anchoring surface of the accessible vehicle;
fastening the accessibility device adjacent to the mounting surface of the mounting structure using the at least one fastener.

2. The method of claim 1, wherein the at least one fastener comprises a PEM stud or welded threaded rod extending upwards normal to the mounting surface, a PEM nut, rivet nut, weld nut, or any other known method of fastening, or any combination thereof.

3. The method of claim 2, wherein the mounting structure comprises at least one bracket and the method further comprises the steps of:
attaching the at least one bracket to a template to locate the at least one bracket in the accessible vehicle before adhering the bonding surface to the anchoring surface.

4. The method of claim 3, wherein the at least one bracket comprises at least a first bracket and a second bracket, wherein the template locates the first bracket relative to the second bracket in the accessible vehicle.

5. The method of claim 4, wherein the anchoring surface is non-planar and wherein the bonding surface of the mounting structure is non-planar in correlation with the non-planar anchoring surface whereby the mounting structure bonds with at least one low point and at least one high point of the non-planar anchoring surface.

6. The method of claim 4, wherein the anchoring surface is non-planar and wherein the bonding surface of the mounting structure is planar and wherein adhering the bonding surface to the anchoring surface involves using at least one shim to bond at least one low point of the non-planar anchoring surface to the planar mounting structure.

7. The method of claim 1, wherein the accessible vehicle has a floor system having a bottom surface configured to adhere to the anchoring surface and a top surface comprising a plurality of tracks configured to secure accessibility devices, the method further comprising the following steps performed in any order:
creating a cavity in the floor system roughly correlating to a profile of one of the accessibility device and the mounting structure; and,
adhering the floor system to the anchoring surface.

8. The method of claim 7, wherein creating the cavity in the floor system includes cutting out at least the top surface of the floor system.

9. The method of claim 7, wherein creating the cavity in the floor system includes installing a plurality of planks of the floor system with a gap between at least two adjacent planks.

10. The method of claim 7, wherein the mounting structure is configured to engage the floor system for additional support.

11. The method of claim 10, wherein a portion of the mounting structure underlaps the floor system when the floor system is installed in the vehicle.

12. The method of claim 10, wherein a portion of the mounting structure is received within an extruded channel of the floor system.

13. The method of claim 10, wherein a portion of the mounting structure engages with at least one of the plurality of tracks.

14. A structure for mounting an accessibility device to a vehicle, comprising:
a bonding surface; and
a mounting surface comprising at least one fastener adapted for connection to the accessibility device, wherein the at least one fastener comprises a PEM stud or welded threaded rod extending upwards from the mounting surface, a PEM nut, rivet nut, weld nut, or any other known method of fastening, or any combination thereof.

15. A vehicle comprising:
an accessibility device;
a floor system with a cavity; and,
a mounting structure disposed within the cavity and comprising a bonding surface bonded to the vehicle and a mounting surface comprising at least one fastener securing the accessibility device to the vehicle.

16. The vehicle of claim 15, wherein the bonding surface is bonded to a non-planar anchoring surface of the vehicle and wherein the bonding surface of the mounting structure is non-planar in correlation with the non-planar anchoring surface, whereby the mounting structure bonds with at least one low point and at least one high point of the non-planar anchoring surface.

17. The vehicle of claim 15, wherein the bonding surface is bonded to a non-planar anchoring surface of the vehicle, wherein the bonding surface of the mounting structure is planar, and further comprising at least one shim bonding at least one low point of the non-planar anchoring surface to the planar mounting structure.

18. The vehicle of claim 15, wherein a portion of the mounting structure underlaps the floor system.

19. The vehicle of claim 15, wherein a portion of the mounting structure is received within an extruded channel of the floor system.

20. The vehicle of claim 15, wherein a top surface of the floor system comprises a plurality of tracks and wherein a portion of the mounting structure engages with at least one of the plurality of tracks.
